(19) United States
(12) Patent Application Publication
(10) Pub. No.: US 2005/0114119 A1
(43) Pub. Date: May 26, 2005

(54) Method of and apparatus for enhancing dialog using formants

(76) Inventors: Yoon-hark Oh, Suwon-si (KR); Hac-kwang Park, Seoul (KR)

Correspondence Address: STANZIONE & KIM, LLP, 1740 N STREET, N.W., FIRST FLOOR, WASHINGTON, DC, 20036, US

(21) Appl. No.: 10/982,827

(22) Filed: Nov. 8, 2004

(30) Foreign Application Priority Data
Nov. 21, 2003 (KR) 2003-82976

(51) Int. Cl. G10L 15/06

(52) U.S. Cl. 704/219

(57) ABSTRACT

A dialog enhancing method and apparatus to boost formants of dialog zones without changing sound zones includes calculating line spectrum pair (LSP) coefficients based on linear prediction coding (LPC) from an input signal, determining whether voice zones exist in the input signal on the basis of the calculated LSP coefficients, and extracting formants from the LSP coefficients according to whether the voice zones exist, and boosting the formants.

### CROSS-REFERENCE TO RELATED APPLICATIONS

This application claims the priority of Korean Patent Application No. 2003-82976, filed on Nov. 21, 2003, in the Korean Intellectual Property Office, the disclosure of which is incorporated herein in its entirety by reference.

### BACKGROUND OF THE INVENTION

1. Field of the Invention

The present general inventive concept relates to a dialog enhancing system, and more particularly, to a dialog enhancing method and apparatus to boost formants of dialog zones without changing sound zones.

2. Description of the Related Art

Commonly, a dialog enhancing system improves the intelligibility of a dialog degraded by background noise. A conventional dialog enhancing system uses equalizers and clipping circuits to increase only a voice volume. However, the equalizers and clipping circuits amplify the dialog and the background noise together.

A conventional dialog enhancing system is disclosed in U.S. Pat. No. 5,459,813 to Klayman, entitled “public address intelligibility system.”

As shown in FIG. 1, the conventional dialog enhancing system includes a voice/unvoice determinator 90, a spectrum analyzer 42, a voltage controlled amplifier (VCA) unit 50, a combining unit 60, and a combiner 108.

Referring to FIG. 1, the voice/unvoice determinator 90 determines whether an input signal is a voice signal or a non-voice signal using a low pass filter. The spectrum analyzer 42 includes 30 filter banks and determines formants by analyzing frequency components of the input signal. The VCA unit 50 controls amplitudes of the formants by applying a gain stored in a gain table to the formants according to the voice/unvoice signal determined by the voice/unvoice determinator 90. The combining unit 60 combines frequency components of the formants, whose amplitudes are controlled by the VCA unit 50, and other frequency bands.

Since the conventional dialog enhancing system uses a number of filter banks to analyze frequencies in the spectrum analyzer 42, a computational amount for this analyzing process is very high, and since gains of the formants are controlled by the VCA unit 50, an envelope of the voice signal becomes distorted.

### SUMMARY OF THE INVENTION

The present general inventive concept provides a dialog enhancing method and apparatus to enhance only a dialog without changing a sound amplitude by enhancing formants according to whether voice zones based on line spectrum pair (LSP) coefficients exist.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a dialog enhancing method comprising calculating line spectrum pair (LSP) coefficients based on linear prediction coding (LPC) from an input signal, (b) determining whether voice zones exist in an input signal according to the calculated LSP coefficients, and extracting formants from the LSP coefficients according to a determination of whether the voice zones exist, and boosting the formants.

The foregoing and/or other aspects and advantages of the present general inventive concept may also be achieved by providing a dialog enhancing method comprising combining input signals of left and right channels, extracting spectrum parameters based on LPC by down sampling the combined signal, determining whether or not voice zones exist according to proximity of LSP coefficients, extracting a plurality of formants from the LSP coefficients according to a determination of whether the voice zones exist, generating boost filter coefficients of a plurality of bands having predetermined levels in center frequencies of the plurality of formants, and if the voice zones exist in the input signals of the left and right channels, filtering the input signals using the boost filter coefficients of the plurality of bands.

The foregoing and/or other aspects and advantages of the present general inventive concept may also be achieved by providing a dialog enhancing apparatus comprising a boost filter coefficient extractor which extracts a plurality of formants by calculating LSP coefficients based on LPC from an input signal, extracts boost filter coefficients corresponding to predetermined levels of the plurality of formants, and determines whether voice zones exist in the input signal on the basis of proximity of the LSP coefficients, and a signal processing unit which enhances formants of the voice zones on the basis of the boost filter coefficients according to a determination of whether the voice zones exist.

The boost filter coefficient extractor may comprise a down sampler which down samples the input signal by a predetermined multiple number, an LPC extractor which extracts the LPC coefficients from the signal down sampled by the down sampler, an LSP converter which converts the LPC coefficients extracted by the LPC extractor into LSP coefficients; a voice zone determinator, which determines whether the voice zones exist by comparing proximity of the LSP coefficients converted by the LSP converter with a threshold value, and a boost filter coefficient generator which calculates center frequencies of the plurality of formants from the LSP coefficients converted by the LSP converter and generates the booster filter coefficients having the same boost gains from the center frequencies of the plurality of formants.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional dialog enhancing system;

FIG. 2 is a block diagram of a dialog enhancing apparatus according to an embodiment of the present general inventive concept;

FIG. 3 is a block diagram of a signal combiner of FIG. 2;

FIG. 4 is a block diagram of a boost filter coefficient extractor of FIG. 2;

FIG. 5 is a flowchart of a dialog enhancing method according to another embodiment of the present general inventive concept;

FIG. 6 is a graph of a spectrum envelope of a voice for p discontinuous frequencies; and

FIG. 7 is a graph of a spectrum envelope of a voice passing through a boost filter of first and second processing units of FIG. 2.

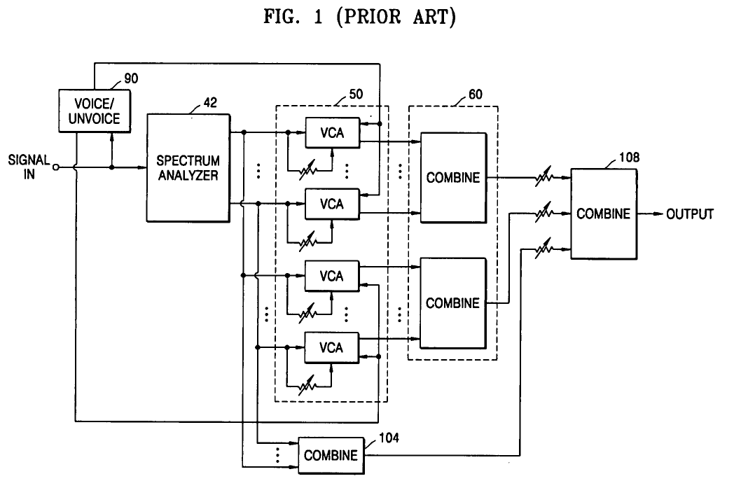

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

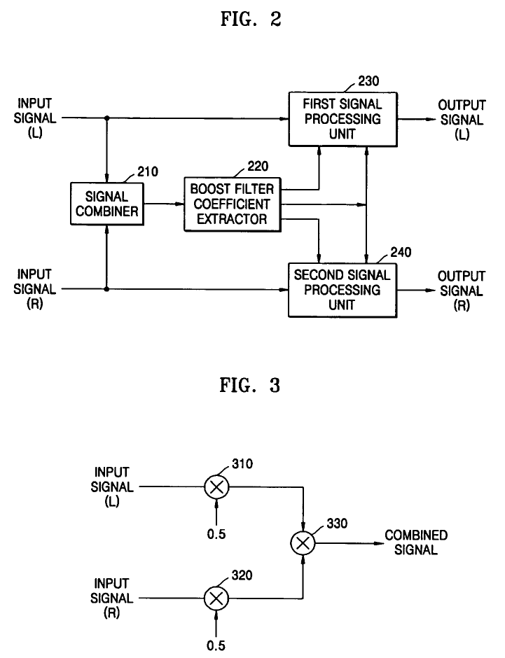

FIG. 2 is a block diagram of a dialog enhancing apparatus according to an embodiment of the present general inventive concept.

Referring to FIG. 2, a signal combiner 210 combines signals input via left and right channels to generate a combined signal. Here, the left and right channel signals include voice signals and background noise.

A boost filter coefficient extractor 220 extracts formants by calculating line spectrum pair (LSP) coefficients and linear prediction coding (LPC) coefficients from the combined signal, extracts boost filter coefficients from the formants, determines whether voice zones exist in the input signals on the basis of proximity of the LSP coefficients, and generates an enhancing select mode (mode select signal) by boosting the input signals according to a determination of whether the voice zones exist.

A first signal processing unit 230 includes a boost filter with 4 bands to which the boost filter coefficients extracted by the boost filter coefficient extractor 220 are applied, and enhances the left input signal by control the left input signal to pass through the 4-band boost filter according to the enhancing select mode.

A second signal processing unit 240 includes a boost filter with 4 bands to which the boost filter coefficients extracted by the boost filter coefficient extractor 220 are applied, and enhances the right input signal by controlling the right input signal to pass through the 4-band boost filter according to the enhancing select mode.

FIG. 3 is a block diagram of the signal combiner 210 of FIG. 2.

Referring to FIGS. 2 and 3, dialog components evenly exist in the left and right channels compared with acoustic components. Therefore, the input signals of the left and right channels are multiplied by 0.5 in a first multiplier 310 and a second multiplier 320, respectively. Then, the signals are added in an adder 330.

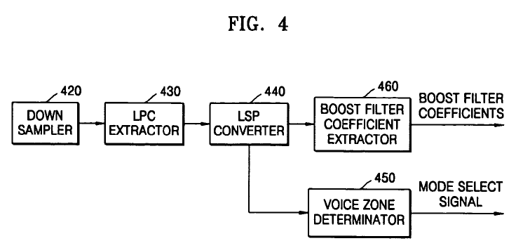

FIG. 4 is a block diagram of the boost filter coefficient extractor 220 of FIG. 2.

Referring to FIGS. 2 through 4, the dialog components have principal frequency components within 4 KHz. A down sampler 420 performs ⅕ down sampling of the combined signal with a sampling frequency 44.1 KHz.

An LPC extractor 430 extracts the LPC coefficients to express a spectrum envelope of a voice component with respect to the signal down sampled by the down sampler 420. Here, 4 formants exist within the 4 KHz in the spectrum of the voice component.

An LSP converter 440 converts the LPC coefficients extracted by the LPC extractor 430 into LSP coefficients. Here, 2 LSP coefficients represent one formant. Also, the sharper and higher the formant is, the narrower a gap of the LSP corresponding to the 2 LSP coefficients is.

A voice zone determinator 450 determines whether or not a voice zone exists, by comparing the gap of the LSP converted by the LSP converter 440 with a threshold value. That is, if the LSP gap is lager than the threshold value, the voice zone determinator 450 determines that there is no voice zone, and generates a bypass signal, and if the LSP gap is smaller than the threshold value, the voice zone determinator 450 determines that there is a voice zone, and generates a boost filtering mode signal (mode select signal).

A boost filter coefficient generator 460 calculates center frequencies of first, second, third, and fourth formants from the LSP coefficients converted by the LSP converter 440 and generates booster filter coefficients having boost gains from the center frequencies of the first, second, third, and fourth formants.

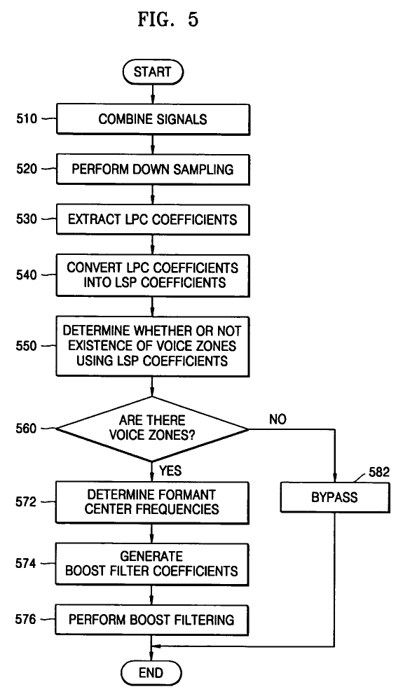

FIG. 5 is a flowchart of a dialog enhancing method according to another embodiment of the present general inventive concept.

Referring to FIGS. 2 through 4, the signals input via the left and right channels are combined in operation 510. Here, the left and right channel signals include center signals, respectively.

Therefore, the left (L) and right (R) channel signals can be represented as L=Lt+Ct and R=Rt+Ct, respectively. Here, Lt is a true L channel signal, Rt is a true R channel signal, and Ct is a true center component. Therefore, the combined input signal can be represented as Xinput=0.5*Lt+0.5*Rt+Ct. Here, Lt≠Rt.

When a sound signal is expressed in a frequency domain, most frequency components exist within 6 KHz, and several frequency bands are dominant. A voice formant is applicable to a dominant band in the frequency domain. Commonly, 4 formants are observed in a voice signal. Also, the formants are placed every 1 KHz. Therefore, first, second, third, and fourth formants exist within 4 KHz. Accordingly, ⅕ down sampling of the combined signal using a sampling frequency 44.1 KHz is performed to reduce a computational amount in operation 520.

The LPC coefficients are extracted from the down sampled signal using an LPC method in operation 530. Here, the LPC method, which is a method of modeling characteristics of a vocal tract among voice generating organs with digital filters having an all-pole structure, is to predict coefficients of digital filters from short zones with 10-20 ms of the voice signal under a presumption that the voice signal is stationary in the short zones with 10-20 ms. Here, the voice signal s(n) can be represented by Equation 1.

$$s ( n ) = {\sum }_{i = 1}^{p} {a}_{1} s ( n - 1 ) + Gu ( n ) \qquad [ Equation 1 ]$$

Here, aᵢ is a linear filter coefficient modeling the vocal tract, G is a gain, and u(n) is an excitation signal.

The linear filter coefficients represent frequency characteristics of a short zone voice signal, and more particularly, well represent information with respect to a resonance frequency (formant) of the vocal tract, which is a meaningful acoustic characteristic.

The LPC coefficients are calculated as shown in Equations 2 through 8 using, for example, a Durbin method using autocorrelation coefficients.
E⁰=r(0) [Equation 2]

Here, E⁰ is an energy of an input signal and r(0) is a first value of the autocorrelation coefficients.

$${k}_{i} = \frac{\{ r ( i ) = {\sum }_{j = 1}^{i - 1} {α}_{j}^{i - 1} r ( \vert i - j \vert )}{{E}^{i - 1}} , 1 \leq 1 \leq p \qquad [ Equation 3 ]$$

Here, kᵢ is an ith reflection coefficient and r(i) is an ith autocorrelation coefficient. Therefore, linear filter coefficients are calculated using Equations 4 and 5.
αᵢ⁽ⁱ⁾=kᵢ [Equation 4]
αⱼ⁽ⁱ⁾=αⱼ⁽ⁱ⁻¹⁾−kᵢαᵢ₋ⱼ⁽ⁱ⁻¹⁾, 1≦j≦i-1 [Equation 5]
Eⁱ=(1−kᵢ²)E⁽ⁱ⁻¹⁾ [Equation 6]

Here, an autocorrelation coefficient r(m) is calculated in advance using Equation 7.

$$r ( m ) = {\sum }_{n = 0}^{N - 1 - m} s ( n ) s ( n + m ) , m = 0 , 1 , … , p \qquad [ Equation 7 ]$$

Here, s(n) is a voice signal.

Eventually, the LPC coefficients can be finally represented as shown in Equation 8.
αₘ=LPC coefficients=αₘ^{(P)}, 1≦m≦p [Equation 8]

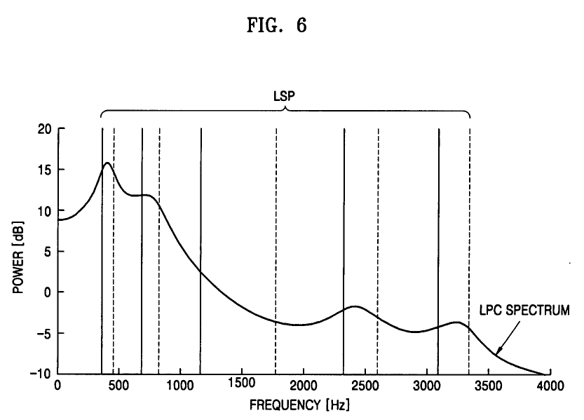

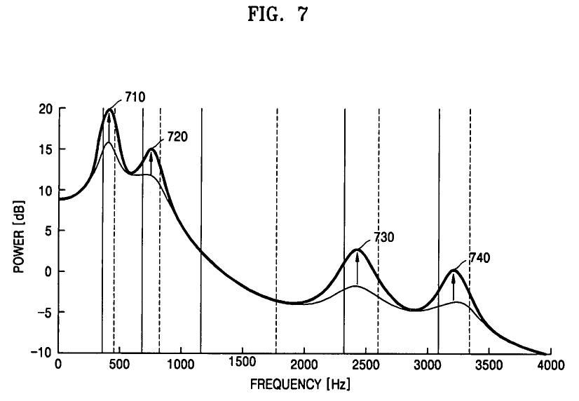

In order to indicate frequency spectrum information of the voice signal, the LSP coefficients are extracted on the basis of the LPC coefficients in operation 540. The line spectrum pair (LSP) indicates the voice spectrum envelope for p discontinuous frequencies as shown in FIG. 6. That is, the LSP is obtained from an LPC model using coefficients based on linear prediction and suggested as another expression type of the LPC coefficients by Itakura-Saito LPC spectral distance.

As shown in Equation 1, the voice signal s(n) can be represented as a filter transfer function H(z)=1/A(z) which performs modeling of a vocal structure. Here, A(z) is equal to Equation 9.
A(z)=1+a₁z⁻¹+ . . . +aₚz^{-p} [Equation 9]

Here, aₚ is a pth grade LPC coefficient.

The LSP can be defined using A(z) as presented in Equations 10 and 11.
P(z)=A(z)+z^{-(P+1)}A(z⁻¹) [Equation 10]
Q(z)=A(z)−z^{-(P+1)}A(z⁻¹) [Equation 11]

Roots of the two defined polynominal expressions P(z) and Q(z) are defined as the LSP.

The LSP coefficients can be obtained from the LPC coefficients and the LPC coefficients can be obtained from the LSP coefficients.

Also, since the polynominal expression P(z) is an even function and the polynominal expression Q(z) is an odd function, a power spectrum |A(\overline{ω})|² can be represented as shown in Equation 12.

$${\vert A ( ϖ ) \vert}^{2} = \frac{1}{4} [ {\vert P ( ϖ ) \vert}^{2} + {\vert Q ( ϖ ) \vert}^{2} ] \qquad [ Equation 12 ]$$

Equation 12 shows that a root of A(z) is closely correlated with the roots of P(z) and Q(z). That is, a formant frequency is represented by gathering 2 or 3 LSP frequencies. Also, a bandwidth of a formant can be expressed according to proximity of a line pair of the LSP. That is, referring to FIG. 6, a greater proximity indicated by a gap between a solid line and a dotted line shows a formant with a narrower bandwidth and a greater amplitude.

Whether the voice zones exist is determined using the LSP coefficients in operation 550. In a voice, a formant has a narrow bandwidth and a great amplitude. Therefore, whether the voice zones exist is determined using the proximity of the LSP. That is, if the LSP gap is smaller than the threshold value, it is determined that there is a voice zone, and if the gap of the LSP is larger than the threshold value, it is determined that there is no voice zone.

If it is determined that there is no voice zone using the proximity of the LSP in operation 560, the input stereo signal is bypassed as it is in operation 582.

If it is determined that there are voice zones using the proximity of the LSP in operation 560, operations 572, 574, and 576 of boosting voice formants are performed as follows.

That is, if it is determined that there are voice zones in the input signal, center frequencies of first, second, third, and fourth formants are determined using the LSP coefficients in operation 572.

4-band boost filter coefficients with boost levels are obtained using the center frequencies of the first, second, third, and fourth formants in operation 574. Here, the boost levels of the formants are all the same so that a spectrum envelope of the voice signal is not varied.

An input stereo signal, e.g., the left or right channel signal, passes through a 4-band boost filter to which the boost filter coefficients are applied in operation 576. FIG. 7 shows an LPC spectrum of a signal having the same boost gains at the first, second, third, and fourth formant bands 710, 720, 730, and 740.

Finally, as shown in FIG. 7, voice zones of the input stereo signal are improved by passing the 4-band boost filter.

The general inventive concept can also be embodied as computer readable codes stored on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to the present invention, the computational amount of a voice detecting/enhancing operation can be reduced by predicting formants using LPC coefficients. Also, since an envelope of a voice signal is not distorted by setting the predetermined gains in first, second, third, and fourth formant bands of the voice signal, a timbre is not varied.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A dialog enhancing method comprising:
calculating line spectrum pair (LSP) coefficients according to linear prediction coding (LPC) from an input signal;
determining whether one or more voice zones exist in the input signal according to the calculated LSP coefficients; and
extracting one or more formants from the LSP coefficients according to a determination of whether the one or more voice zones exist, and boosting the formants.

2. The method of claim 1, wherein the calculating of the line spectrum pair coefficients comprises:
extracting LPC coefficients by applying a LPC model to the input signal; and
converting the LPC coefficients into the LSP coefficients using a predetermined LPC model.

3. The method of claim 1, wherein the determining of the whether the voice zone exists comprises determining that the input signal is a voice signal if an LSP gap is smaller than a threshold value, and determining that the input signal is not the voice signal if the LSP gap is larger than the threshold value.

4. The method of claim 1, wherein the extracting of the formants comprises:
determining center frequencies of the formants using the LSP coefficients if there are the voice zones in the input signal;
generating boost filter coefficients with a boost level in the center frequencies of the formants;
boosting the formants of the input signal using the boost filter coefficients.

5. The method of claim 4, wherein the boost level is set to the same amplitude for each formant.

6. The method of claim 4, further comprising:
preventing the formants from being boosted if the input signal is not the voice signal.

7. The method of claim 1, wherein the calculating of the LSP coefficients comprising:
determining center frequencies of the one or more formants according to the LSP coefficients; and
extracting boost filter coefficients to be used to boost the formants, according to the center frequencies.

8. The method of claim 1, wherein the boosting of the formants comprises:
boosting the formants according to the boost filter coefficients by a same boosting level.

9. A dialog enhancing method comprising:
combining input signals of left and right channels to generate a combined signal;
extracting spectrum parameters based on linear prediction codes by down sampling the combined signal;
determining whether one or more voice zones exist according to an LSP gap;
extracting one or more formants from LSP corresponding to the spectrum parameters according to whether the one or more voice zones exist;
generating boost filter coefficients of a plurality of bands having predetermined levels in center frequencies of the one or more formants; and
filtering the input signals using the boost filter coefficients of the plurality of bands if the one or more voice zones exist in the input signals.

10. A dialog enhancing apparatus comprising:
a boost filter coefficient extractor which extracts one or more formants by calculating LSP coefficients based on linear prediction codes from an input signal, extracts boost filter coefficients corresponding to predetermined levels of the one or more formants, and determines whether one or more voice zones exist in the input signal according to an LSP gap; and
a signal processing unit which enhances the one or more formants of the voice zones according to the boost filter coefficients a determination of whether the voice zones exist.

11. The apparatus of claim 10, further comprising:
a signal combiner which combines the input signals input via the left and right channels and outputs the combined signal to the boost filter coefficient extractor.

12. The apparatus of claim 10, wherein the boost filter coefficient extractor comprises:
a down sampler which down samples the input signal by a predetermined multiple number;
an LPC extractor which extracts LPC coefficients from the down sampled signal by the down sampler;
an LSP converter which converts the LPC coefficients extracted by the LPC extractor into LSP coefficients;
a voice zone determinator which determines whether the voice zones exists, by comparing the LSP gap with a threshold value; and
a boost filter coefficient generator which calculates center frequencies of the one or more formants from the LSP coefficients and generates booster filter coefficients having predetermined boost gains from the center frequencies of the one or more formants.

13. The apparatus of claim 12, wherein if the LSP gap is larger than the threshold value, the voice zone determinator generates a bypass mode signal by determining that the input signal is not a voice signal, and if the LSP gap is smaller than the threshold value, the voice zone determinator generates a boost filtering mode signal by determining that the input signal is a voice signal.

14. The apparatus of claim 10, wherein the signal processing unit comprises a 4-band boost filter to which boost filter coefficients extracted by the boost filter coefficient extractor are applied.

15. The apparatus of claim 10, wherein the input signal comprises a left channel signal and a right channel signal, and the signal processing unit comprises a first signal processing unit to enhance the left channel signal of the input signal according to the determination and the boost filter coefficients, and a second signal processing unit to enhance the right channel signal of the input signal according to the determination and the boost filter coefficients.

16. The apparatus of claim 10, wherein the input signal comprises a non-voice zone, and the signal processing unit prevents the input signal corresponding to the non-voice zone from being enhanced.

17. The apparatus of claim 10, wherein the boost filter coefficients have the same boost gain to be applied to the one or more formants.

18. The apparatus of claim 10, wherein the signal processing unit comprises a plurality of boost filters to enhance the one or more formants of the voice zones by the same level.

19. The apparatus of claim 10, wherein the boost filter coefficient extractor determines center frequencies of the one or more formants according to the LSP coefficients, and extracts the boost filter coefficients according to the center frequencies of the one or more formants.

20. A computer readable storage medium containing a dialog enhancing method, the dialog enhancing method comprising:
calculating line spectrum pair (LSP) coefficients according to linear prediction coding (LPC) from an input signal;
determining whether one or more voice zones exist in the input signal according to the calculated LSP coefficients; and
extracting one or more formants from the LSP coefficients according to a determination of whether the one or more voice zones exist, and boosting the one or more formants.
